(19) United States
(12) Patent Application Publication
(10) Pub. No.: US 2019/0003806 A1
(43) Pub. Date: Jan. 3, 2019

(54) MULTILAYER PLATE

(71) Applicant: Slawomir GAJDZINSKI, Szczeon (PL)

(72) Inventor: Slawomir GAJDZINSKI, Szczeon (PL)

(21) Appl. No.: 15/748,636

(22) PCT Filed: Jul. 29, 2016
(86) PCT No.: PCT/PL2016/000085

§ 371 Date: Jan. 29, 2018

(30) Foreign Application Priority Data
Jul. 30, 2015 (PL) P.413342

(51) Int. Cl. F41H 5/04; B32B 15/04; B32B 15/14; B32B 15/16; B32B 15/18; B32B 15/20; B32B 27/06; B32B 3/12; B32B 3/28; B32B 5/08; B32B 5/16; B32B 5/30; B32B 7/04; B32B 7/12; B32B 9/00; B32B 9/02; B32B 9/04

(52) U.S. Cl. CPC F41H 5/0421; B32B 2250/05; B32B 15/14; B32B 15/16; B32B 15/18; B32B 15/20; B32B 27/06; B32B 3/12; B32B 3/28; B32B 5/08; B32B 5/16; B32B 5/30; B32B 7/045; B32B 7/12; B32B 9/005; B32B 9/02; B32B 9/041; F41H 5/0428; F41H 5/0457; F41H 5/0478; B32B 2260/025; B32B 2260/046; B32B 2260/048; B32B 2262/0253; B32B 2262/101; B32B 2262/14; B32B 2264/0207; B32B 2264/06; B32B 2307/56; B32B 2307/581; B32B 2571/02; B32B 2605/08; B32B 2607/00; B32B 15/04

(57) ABSTRACT

A multilayer plate comprising reinforcement layers made of metal or ceramic or glass or plastics, or of aramid, aramid-glass, glass or ultra-high-molecular-weight polyethylene (UHMWPE) fabric, or made of a combination thereof and shock absorbing layers, wherein the shock absorbing layer is made of cork while the layers are secured to one another permanently. The multilayer plate has a shock absorbing layer preferably made of cork agglomerate or expanded cork or a compound of cork and other elastic substances or a compound of cork and rubber or a compound of cork and polyurethane or a compound of cork and rubber and polyurethane. The plate may comprise a shock absorbing layer which internally contains additional spatial shock absorbing layers, preferably corrugated, or trapezoid-, triangular-, cubic- or honeycomb-shaped. The reinforcement layer is preferably mace of aluminum or duralumin or titanium or armor steel. The layers are secured to one another permanently by gluing or thermoplastic bonding or lamination or pressing or by using the RTM infusion or LRTM infusion methods or the CCBM process.

The subject of invention is a multilayer plate designed for protection against penetration, particularly by bullets from firearms.

There exist a number of multilayer plates serving as armor plates for protection against penetration by bullets from firearms, of various calibers and types.

From patent specification no. PL172656 is known the multilayer armor comprising an armor plate to which a catcher layer made of multilayer fabric is adjoined, to which a shock absorbing layer made of elastomer is bonded, to which then a securing layer made of multilayer fabric is bonded, all secured to one another permanently. The aforesaid solution is dedicated to protective clothing and has a limited range of applications due to its high net unit weight and its level of protection against puncture and is designed for protection against bullets from handguns.

From patent application no. PL404286 is known the passive modular layered armor comprising two aluminum alloy layers, an armor steel layer, a second rolled armor steel layer, a light-weight plastic layer and a thin aluminum alloy sheet layer. A second variant of this solution does not contain a light-weight plastic layer. The aforesaid solution is dedicated to protection against up to 14.5 mm caliber bullets and to applications on fixed structures and vehicles, but due to its high net unit weight its range of applications is limited.

From patent application no. PL406578 is known the flexible armor comprising a ceramic layer made of spatial elements, a front stack of layers behind which is placed a layer of sacs containing liquid with viscosity which grows as shear rate increases, and a rear stack of aramid and/or polyethylene layers. The aforesaid solution is dedicated to protection against up to 14.5 mm caliber bullets, while it additionally protects against puncture by shrapnel and explosions. It is also suitable for use as an insert for bulletproof vests, but due to its complex manufacturing process and limited protection ability, as well as its high net unit weight, its range of applications is limited.

The multilayer plate according to the present invention comprises reinforcement layers made of metal or ceramic or glass or plastics, or of aramid, aramid-glass, glass or ultra-high-molecular-weight polyethylene (UHMWPE) fabric, or made of a combination thereof and shock absorbing layers, wherein the shock absorbing layer is made of cork while the layers are secured to one another permanently. A preferred variant of the solution is where the shock absorbing layer is made of cork agglomerate or expanded cork or a compound of cork and other elastic substances. A particularly preferable variant of the solution is where the shock absorbing layer is made of a compound of cork and rubber, or a compound of cork with polyurethane or a compound of cork and rubber and polyurethane. The multilayer plate as per present invention may comprise a shock absorbing layer which internally contains additional spatial shock absorbing layers, preferably corrugated, or trapezoid-, triangular-, cubic- or honeycomb-shaped. The reinforcement layer is preferably made of aluminum or duralumin or titanium or armor steel—as needed. In the plate as per present invention, the layers are preferably secured together by gluing or thermoplastic bonding or lamination or pressing or are preferably secured together using the RTM (Resin Transfer Molding) infusion or LRTM (Light Resin Transfer Molding) infusion methods or the CCBM (Closed Cavity Bag Molding) process.

The multilayer plate as per present invention is characterized by a very low net unit weight while maintaining high resistance to puncture. Moreover, it is suitable for shaping as required, can be used as a proper protection on its own or can support other types of armor. The plate can be used for manufacturing structural elements or insulation elements in automotive, building and transport industries.

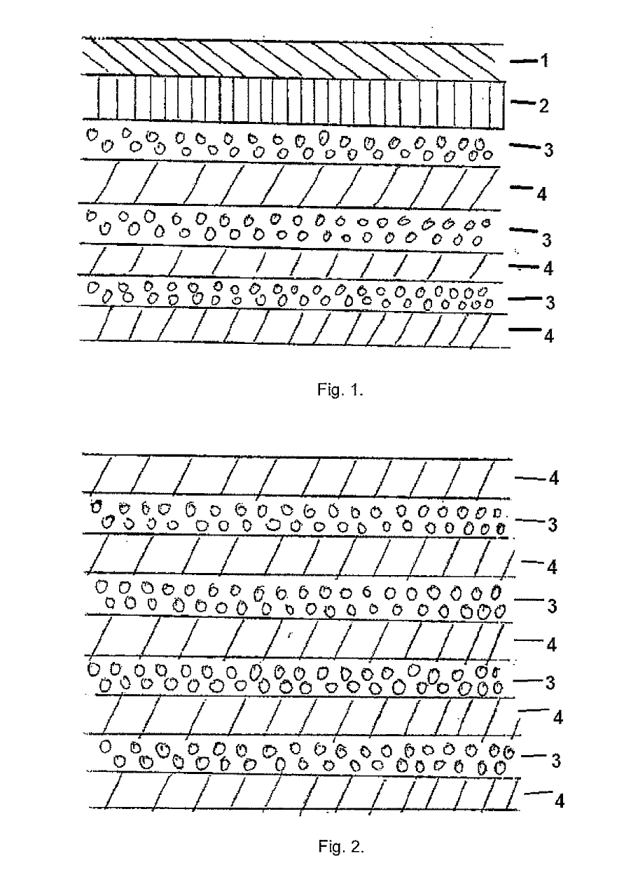

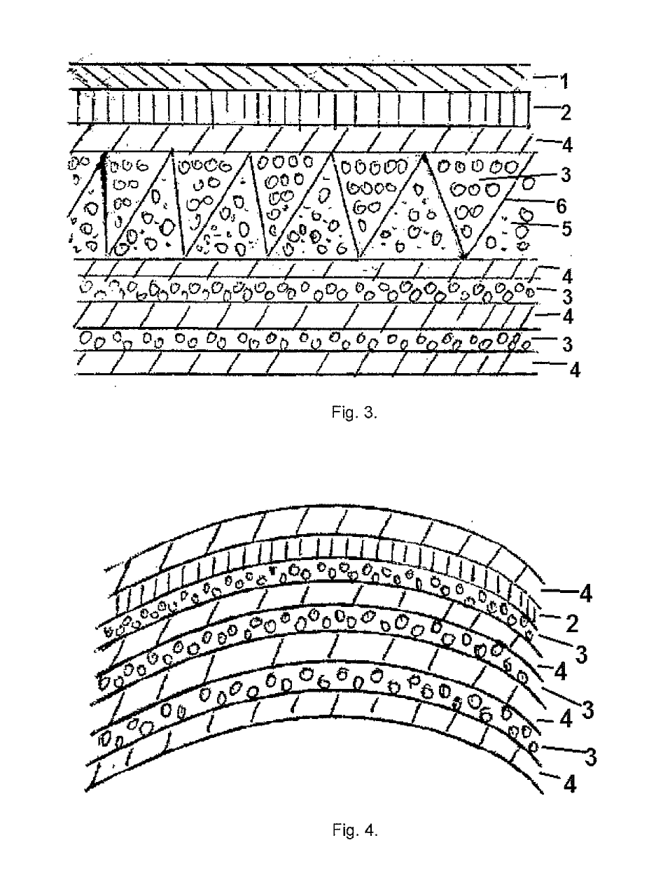

The subject of the invention is shown in its embodiments and in drawings, where FIG. 1 shows, respectively, a cross-section of the plate with the application of many layers, FIG. 2 shows a cross-section of the titan-cork version of the plate, FIG. 3 shows, respectively, a cross-section of the plate with an additional spatial shock absorbing layer, and FIG. 4 shows a cross-section of the titan-cork version of the plate with the application of an aramid layer, bend-shaped.

In the first embodiment of the multilayer plate as per present invention, in order from the outer side inwards, there is a reinforcement layer made of glass 1, to which another reinforcement layer made of aramid fabric 2 is bonded, to which a shock absorbing layer made of cork 3 is bonded, to which subsequently another reinforcement layer made of titanium 4 is bonded, to which subsequently another layer of cork 3, another layer of titanium 4, and then the last layer of cork 3 and the last layer of titanium 4 are bonded. The plate is characterized by high resistance to puncture. All the layers are secured to one another permanently with the use of glue.

In the second embodiment of the multilayer plate as per present invention, in order from the outer side inwards, there is a reinforcement layer made of titanium 4, to which a shock absorbing layer made of cork 3 is glued. This combination of layers is then repeated three times, where the last layer is again made of titanium 4. This plate is characterized by a very low net unit weight and, at the same time, maintains high resistance to puncture, for up to 7.62 mm caliber inclusive. All the layers are secured to one another permanently with the use of glue.

In the third embodiment of the multilayer plate as per present invention, in order from the outer side inwards, there is a reinforcement layer made of glass 1, to which a reinforcement layer made of aramid fabric 2 is bonded, to which another reinforcement layer made of titanium 4 is bonded. To this layer, a spatial shock absorbing layer made of polyurethane 6 is bonded, the free spaces of which are filled on the one side with a shock absorbing-layer 3 made of cork, and on the other side with a shock absorbing layer 5 made of a compound of cork and rubber. Subsequently, the combination of the titanium 4—cork 3 layers is repeated twice, where the last layer is again made of titanium 4. All the layers are secured to one another permanently with the use of glue.

In the fourth embodiment of the multilayer plate as per present invention, in order from the outer side inwards, there is a reinforcement layer in its rounded version to protect convex elements. The outer layer of the reinforcement comprises a layer of titanium 4 and aramid 2, and then a combination of cork 3—titanium 4 layers is repeated three times. All the layers are secured to one another permanently with the use of infusion. The lamination process can be used, as well.

The plate manufactured as per foregoing embodiments has a substantially lower unit weight than a plate made of steel. The plate can be built in such a manner that titanium can be replaced with aluminum or duralumin, preferably with the addition of aramid fabric.

1. A multilayer plate comprising reinforcement layers made of metal or ceramic or glass or plastics, or of aramid, aramid-glass, glass or ultra-high-molecular-weight polyethylene (UHMWPE) fabric, or made of a combination thereof and shock, absorbing layers, wherein the shock absorbing layer is made of cork while the layers are secured to one another permanently.

2. The multilayer plate according to claim 1, characterized in that the shock absorbing layer is preferably made of cork agglomerate.

3. The multilayer plate according to claim 1, characterized in that the shock absorbing layer is preferably made of expanded cork.

4. The multilayer plate according to claim 1, characterized in that the shock absorbing layer is made of a compound of cork and other elastic substances.

5. The multilayer plate according to claim 1, characterized in that the shock absorbing layer is preferably made of a compound of cork and rubber.

6. The multilayer plate according to claim 1, characterized in that the shock absorbing layer is preferably made of a compound of cork and polyurethane.

7. The multilayer plate according to claim 1, characterized in that the shock absorbing layer is preferably made of a compound of cork and rubber and polyurethane.

8. The multilayer plate according to claim 1, characterized in that the shock absorbing layer contains internally additional spatial shock absorbing layers, preferably corrugated, or trapezoid-, triangular-, cubic- or honeycomb-shaped.

9. The multilayer plate according to claim 1, characterized in that the reinforcement layer is preferably made of aluminum.

10. The multilayer plate according to claim 1, characterized in that the reinforcement layer is preferably made of duralumin.

11. The multilayer plate according to claim 1, characterized in that the reinforcement layer is preferably made of titanium.

12. The multilayer plate according to claim 1, characterized in that the reinforcement layer is preferably made of armor plate.

13. The multilayer plate according to claim 1, characterized in that the layers are preferably secured to one another by gluing.

14. The multilayer plate according to claim 1, characterized in that the layers are preferably secured to one another by thermoplastic bonding.

15. The multilayer plate according to claim 1, characterized in that the layers are preferably secured to one another by lamination.

16. The multilayer plate of claim 1, characterized in that the layers are preferably secured to one another by pressing.

17. The multilayer plate according to claim 1, characterized in that the layers are preferably secured to one another using the RTM infusion method.

18. The multilayer plate according to claim 1, characterized in that the layers are preferably secured to one another using the LRTM infusion method.

19. The multilayer plate according to claim 1, characterized in that the layers are preferably secured to one another using the CCBM process.
